(19) United States
(12) Patent Application Publication
(10) Pub. No.: US 2025/0332070 A1
(43) Pub. Date: Oct. 30, 2025

(54) Enteral Feeding Bottle

(71) Applicant: Avent, Inc., Alpharetta, GA (US)

(72) Inventors: James M. Takeuchi, Woodstock, GA (US); Michael A. Kenowski, Alpharetta, GA (US); Geetanshu Madan, Woodstock, GA (US)

(21) Appl. No.: 18/645,685

(22) Filed: Apr. 25, 2024

(51) Int. Cl. A61J 9/00; A61J 15/00

(52) U.S. Cl. CPC A61J 9/001; A61J 15/0026

(57) ABSTRACT

An enteral feeding bottle is provided and includes a body having an exterior and an interior chamber. The body further includes an opening to the interior chamber of the body and a base and a flanged rim along the opening where the body is formed from a flexible material such as a silicone or a thermoplastic elastomer. The enteral feeding bottle also includes a connecting ring configured to interlock with the flanged rim of the body. The enteral feeding bottle also includes an enteral feeding device adaptor configured to removably connect with the connecting ring where the enteral feeding device adaptor includes an opening configured to be removably connected with an enteral feeding device. Once assembled, a seal is formed between the flanged rim, the connecting ring, and the enteral feeding device adaptor.

### FIELD OF THE INVENTION

The subject matter of the present invention relates generally to a custom bottle for enteral feeding.

### BACKGROUND

There are many issues encountered by users of enteral feeding devices today. For example, individual users requiring long-term enteral feeding are limited by the types of containers available to both store and administer liquid nutrition. Specifically, the containers are typically either a plastic bag when the liquid nutrition is delivered using a pump, or a syringe barrel when the nutrition is delivered via a bolus modality.

While suitable for their applications, plastic bags and syringe barrels may not be able to be used interchangeably should an individual user wish to transition from a pump delivery system to a bolus modality delivery system. For example, although a syringe may be particularly suitable for bolus modality delivery systems, a syringe may not be able to provide the same volume of liquid nutrition as a plastic bag. Alternatively, although a plastic bag may allow for continuous flow when using a pump, a plastic bag may not allow for a flow of liquid nutrition as controlled when compared to a syringe.

In addition, both plastic bags and syringes may create difficulties when storing liquid nutrition. For example, plastic bags may not rest stably on a surface when stored for periods of time, while syringes may not be capable of storing larger quantities of liquid nutrition. For syringes, a separate storage container may need to be provided from which doses of liquid nutrition are extracted when it is time for enteral feeding. For both plastic bags and syringes, the liquid nutrition contained may be prone to spilling and/or leaking, which may lead to frustration and dissatisfaction from the individual user.

Accordingly, improved systems for containing liquid nutrition are desired in the art. In particular, an enteral feeding bottle which addresses the aforementioned considerations would be advantageous.

### SUMMARY

Objects and advantages of the invention will be set forth in part in the following description, or may be obvious from the description, or may be learned through practice of the invention.

In accordance with one aspect, an enteral feeding bottle is provided. The enteral feeding bottle includes a body including an exterior and an interior chamber, the body further includes an opening to the interior chamber of the body and a base, the body further includes a flanged rim along the opening where the body is formed from a flexible material where the flexible material includes silicone or a thermoplastic elastomer; a connecting ring configured to interlock with the flanged rim of the body; an enteral feeding device adaptor configured to removably connect with the connecting ring, the enteral feeding device adaptor including an opening configured to be removably connected with an enteral feeding device where a seal is formed between the flanged rim, the connecting ring, and the enteral feeding device adaptor.

In one embodiment of the enteral feeding bottle, the flanged rim defines an expanded state and a constricted state where a minimum circumference of the connecting ring is smaller than a maximum circumference of the flanged rim in the expanded state.

In another embodiment of the enteral feeding bottle, the maximum circumference of the flanged rim in the constricted state is equal to or smaller than the maximum circumference of the connecting ring.

In a further embodiment of the enteral feeding bottle, a maximum circumference of the connecting ring is about equal to a maximum circumference of the body.

In an additional embodiment of the enteral feeding bottle, the body defines an angled portion where the connecting ring is configured to surround the angled portion when the connecting ring is interlocked with the flanged rim.

In yet another embodiment of the enteral feeding bottle, the connecting ring includes external threads and the enteral feeding device adaptor includes internal threads where the external threads of the connecting ring are configured to interlock with the internal threads of the enteral feeding device adaptor.

In still another embodiment of the enteral feeding bottle, the enteral feeding device adaptor includes a tethered cap.

In yet a further embodiment of the enteral feeding bottle, the base of the body includes a hole arranged about an axis where the axis of the hole is approximately perpendicular to an axis about which the opening of the body is arranged.

In still a further embodiment of the enteral feeding bottle, the base of the body includes a lipped bottom configured to provide a vacuum lock when placed on a surface.

In another additional embodiment of the enteral feeding bottle, the body, the connecting ring, and the enteral feeding device adaptor each include a cylinder.

In a further additional embodiment of the enteral feeding bottle, the opening of the enteral feeding device adaptor includes external threads where the external threads of the enteral feeding device adaptor are configured to be interlocked with internal threads of the enteral feeding device.

In yet another additional embodiment of the enteral feeding bottle, the connecting ring and the enteral feeding device adaptor include a rigid material.

In still another additional embodiment of the enteral feeding bottle, the body of the enteral feeding bottle is compressible in a radial direction and not compressible in an axial direction.

In another embodiment of the enteral feeding bottle, the flanged rim forms a channel between an upper section of the body of the enteral feeding bottle and the flanged rim, and the connecting ring includes a protrusion extending in an axial direction and configured to be inserted within the channel.

In a further embodiment of the enteral feeding bottle, the flanged rim is configured to be compressed between the protrusion of the connecting ring and an inner surface of the enteral feeding device adaptor to form the seal.

In an additional embodiment of the enteral feeding bottle, the protrusion extends about a circumference of the connecting ring.

In accordance with another aspect, an enteral feeding system is provided. The enteral feeding system includes an enteral feeding bottle which includes a body including an exterior and an interior chamber, the body further includes an opening to the interior chamber of the body and a base, the body further includes a flanged rim along the opening where the body is formed from a flexible material where the flexible material includes silicone or a thermoplastic elastomer; a connecting ring configured to interlock with the flanged rim of the body; and an enteral feeding device adaptor configured to removably connect with the connecting ring, the enteral feeding device adaptor including an opening configured to be removably connected with an enteral feeding device where a seal is formed between the flanged rim, the connecting ring, and the enteral feeding device adaptor. The enteral feeding system further includes an enteral feeding device including a nutrition adapter including a coupling configured to fluidly couple with the enteral feeding device adaptor; a tube fluidly coupled to the nutrition adapter; and a feeding tube adapter fluidly coupled to the tube where the nutrition adapter, the tube, and the feeding tube adapter are formed as one piece.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side, cross-sectional view of an enteral feeding bottle according to one particular embodiment of the present invention;

FIG. 2a illustrates a side, cross-sectional view of a flanged rim and a connecting ring of the enteral feeding bottle of FIG. 1;

FIG. 2b illustrates a side view of the flanged rim and the connecting ring of the enteral feeding bottle of FIG. 1;

FIG. 3 illustrates a perspective view of the body of the enteral feeding bottle of FIG. 1;

FIG. 4 illustrates another perspective view of the body of the enteral feeding bottle of FIG. 1;

FIG. 5 illustrates a perspective view of a bolus feed delivery system according to one particular embodiment of the present invention;

FIG. 6 illustrates a perspective view of the bolus feed delivery system of FIG. 5, particularly showing the bolus delivery system being positioned for coupling to a source of enteral nutrition according to a particular embodiment of the present invention;

FIG. 7 illustrates a perspective view of an enteral feeding system according to one particular embodiment of the present disclosure; and

FIG. 8 illustrates a perspective view of the enteral feeding system of FIG. 7, particularly showing the enteral feeding system being used with a peristaltic pump according to one particular embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first,” “second,” and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise. Further, when a plurality of ranges are provided, any combination of a minimum value and a maximum value described in the plurality of ranges are contemplated by the present invention. For example, if ranges of “from about 20% to about 80%” and “from about 30% to about 70%” are described, a range of “from about 20% to about 70%” or a range of “from about 30% to about 80%” are also contemplated by the present invention.

As will be used herein, the terms proximal and distal each refer to a point of reference in relation to a particular object. Specifically, the term proximal is defined as being situated nearer the object of reference, while the term distal is defined as being situated further from the object of reference. As described herein, the object of reference is a source of nutrition, such as the enteral feeding bottle described herein. Thus, an object that is proximal is closer to the source of nutrition, while an object that is distal is further from the source of nutrition.

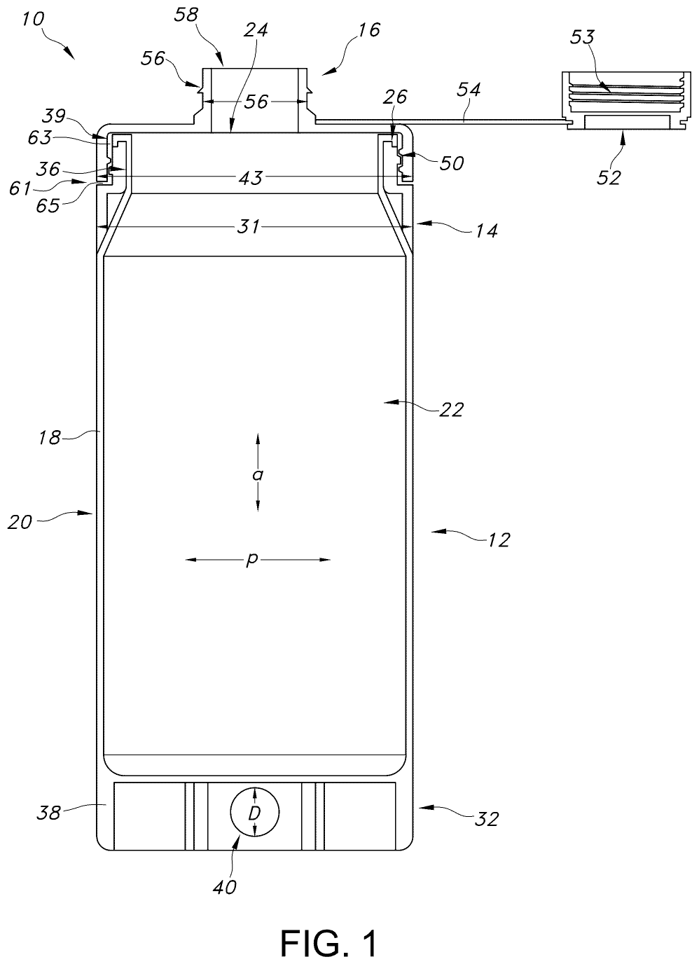

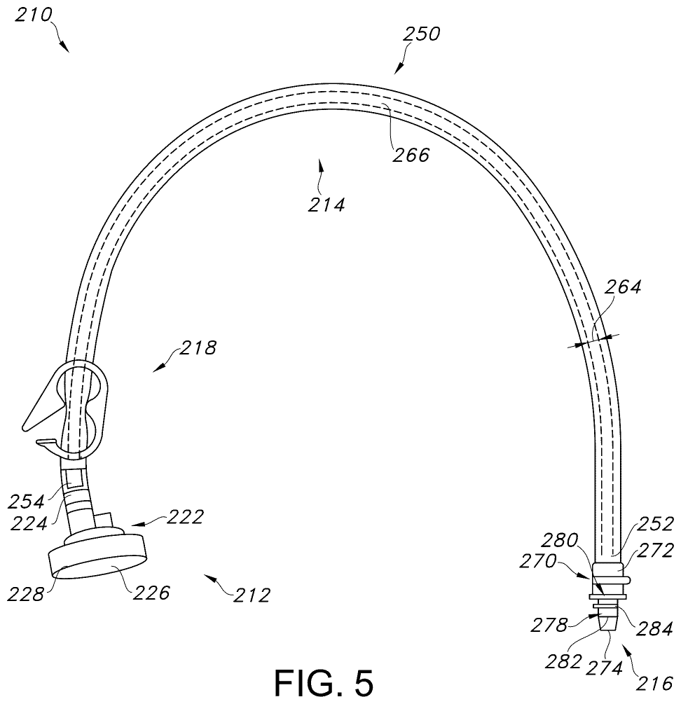

Generally speaking, the present invention is directed to an enteral feeding bottle and an enteral feeding system using the enteral feeding bottle. The enteral feeding bottle includes a body, a connecting ring, and an enteral feeding device adaptor which together form a seal with each other when joined. To achieve a seal, the body is formed from a flexible material and includes a flanged rim along the opening of the body. In addition, to achieve a seal, the connecting ring is shaped and configured to interlock with the flanged rim of the body. Further, to achieve a seal, the enteral feeding device adaptor is shaped and configured to removably connect with the connecting ring and provide a connection point for an enteral feeding device. Thus, when the flanged rim, the connecting ring, and the enteral feeding device adaptor are connected a seal is formed. Such a seal can reduce the possibility of leaking or spilling of contents contained within the enteral feeding bottle. Thus, as will be discussed in greater detail hereinbelow, the enteral feeding bottle of the present invention provides a simpler, easier-to-use, and more consumer-friendly solution for nutrition storage and delivery. Moreover, when the enteral feeding bottle is used with an enteral feeding device, an enteral feeding system is provided which can provide further advantages to a consumer. The specific features of such an enteral feeding bottle may be better understood with reference to FIGS. 1-4 while the enteral feeding system may be better understood with reference to FIGS. 5-8.

Referring now to FIG. 1, one embodiment of an enteral feeding bottle 10 is shown. It should be understood that although the feeding bottle 10 is referred to as an “enteral” feeding bottle 10, the feeding bottle 10 should not be construed as limited as only being used with enteral feeding. The feeding bottle 10 may be used for storage of any liquid, e.g., for feeding, drinking, or other storage. Nutrition storage, including that of blenderized food, may include both refrigeration and freezer storage. In some aspects, the feeding bottle 10 may be used with an enteral feeding system or a bolus delivery feeding system as will be discussed in greater detail herein below.

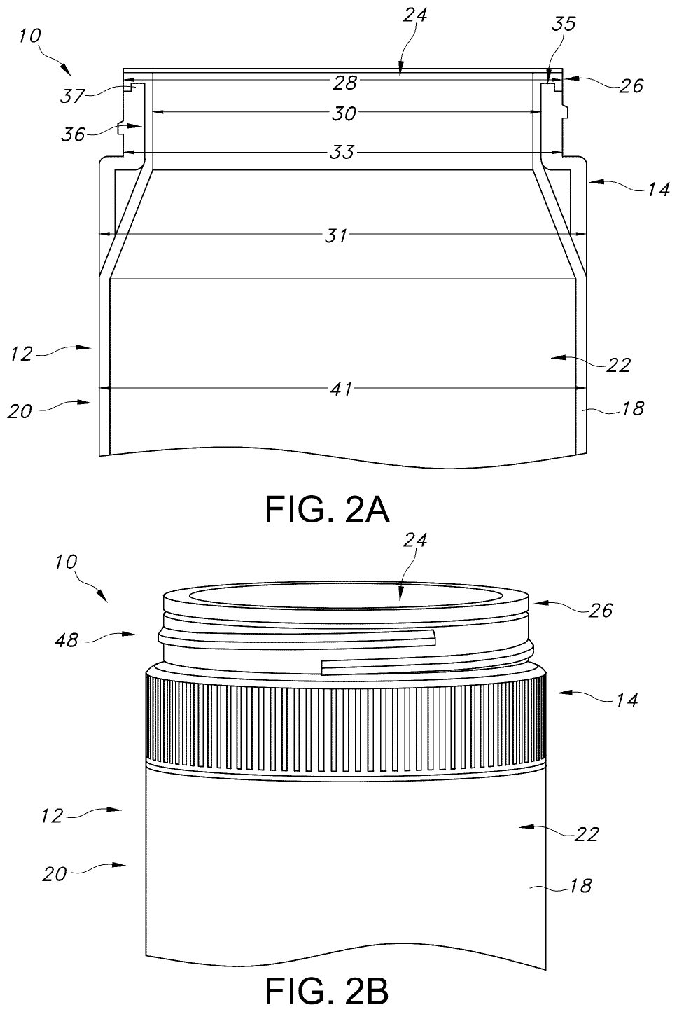

As shown in FIG. 1, the enteral feeding bottle 10 includes a body 12, a connecting ring 14, and an enteral feeding device adaptor 16. The body 12 includes a wall 18 which defines an exterior 20 and an interior chamber 22. An opening 24 is provided on the body 12 to the interior chamber 22, and a flanged rim 26 is provided along the opening 24. The flanged rim 26 may define a maximum circumference 28 and a minimum circumference 30 (See FIG. 2a). As discussed above and will be discussed below, the term “circumference” should not be construed as limiting the shape of the enteral feeding bottle 10 or any of the components of the enteral feeding bottle 10 to a circular shape. Rather, the enteral feeding bottle may take any shape that allows for a seal between the body 12, the connecting ring 14, and the enteral feeding adaptor 16 to be formed. For example, in an exemplary embodiment, the body 12, the connecting ring 14, and the enteral feeding adaptor 16 may each be a cylinder or have a generally cylindrical shape. The body 12, the connecting ring 14, and the enteral feeding adaptor 16 may also have an oval cross-sectional shape or a generally round cross-sectional shape.

Returning to the body 12, the body 12 also includes a base 32. The body 12 may also include an angled portion 34 which may meet with the connecting ring 14. The body 12 is formed from a flexible material such as a silicone or a thermoplastic elastomer. Such a material enables the body 12 of the enteral feeding bottle 10 to be compressible in a radial direction p. However, the body 12 may be generally incompressible in an axial direction a that is perpendicular to the radial direction p. The incompressible nature of the body 12 in the axial direction a may also be achieved by the material from which the body 12 is formed. In addition or in combination, the incompressible nature of the body 12 in the axial direction a may also be achieved or enhanced by interlocking the connecting ring 14 with the flanged rim 26 on an upper section 36 of the body 12. For example, if the connecting ring 14 is formed from a rigid material such as a thermoset elastomer, the body 12 may not be compressible in the axial direction a because the rigid material of the connecting ring 14 prevents such compression. Similarly, the enteral feeding device adaptor 16 may also be formed from a rigid material such as a thermoset elastomer which may also further enhance the incompressibility of the body 12 in the axial direction a.

Further, the incompressible nature of the body 12 in the axial direction a may also be achieved or enhanced by providing the base 32 with a wall 38 which is thicker in a radial direction than the wall 18 of the other portions of the body 12. The thicker wall 38 may also give the body 12 greater stability when placed upon a surface. By providing a body 12 of an enteral feeding bottle 10 with such partial compressibility, the enteral feeding bottle 10 may be squeezed in the radial direction p to deliver contents of the interior chamber 22 through the enteral feeding device adaptor 16 without worrying about the enteral feeding bottle 10 compressing in the axial direction a and disrupting a seal formed between the body 12, the connecting ring 14, and the enteral feeding device adaptor 16.

In addition, as a consequence of the partial compressibility of the body 12, the flanged rim 26 of the body 12 may also be capable of expanding and being constricted such that the flanged rim 26 defines an expanded state and a constricted state. Such a change in states (expanded vs. contracted/constricted) may enable the body 12 to better form with the connecting ring 14 as will be discussed in greater detail hereinbelow.

The body 12 may also have a certain liquid volume capacity to provide sufficient nutrition to a consumer who would use the enteral feeding bottle. For example, the internal chamber 22 of the body 12 may be configured to hold a liquid volume of about equal to or greater than 300 millimeters (mL), such as equal to or greater than 400 mL, such as equal to or greater than 500 mL, and less than about 4000 mL.

The base 32 of the body 12 may also include a hole 40 arranged about an axis 42, such as an axis in the radial direction p. The axis 42 of the hole 40 may be perpendicular to an axis 44, such as an axis in the axial direction a, about which the opening 24 of the body 12 is arranged. The hole 40 may define a diameter D for use for enteral feeding such as approximately 0.1 to 1.0 inches (0.25 cm to 2.5 cm), such as 0.2 to 1.1 inches (0.5 cm to 2.75 cm), such as 0.3 to 1.2 inches (0.75 cm to 3 cm). By providing such a hole 40, the enteral feeding bottle 10 may be hung via the hole 40 in a generally vertical arrangement to provide gravity assist for delivering fluid through the enteral feeding device adaptor 16 and generally provide ease of use by enabling hanging or mounting the bottle 10. For example, the hanging the enteral feeding bottle 10 from the hole 40 may help better facilitate an enteral feeding device or a bolus delivery feeding device such as the enteral feeding device or the bolus delivery feeding device which will be discussed in greater detail hereinbelow. To make the hole 40 more accessible for use, the hole 40 may be defined on a sloped surface 45 formed between a circumferential outer wall of the bottle 10 and the base 32 of the bottle 10.

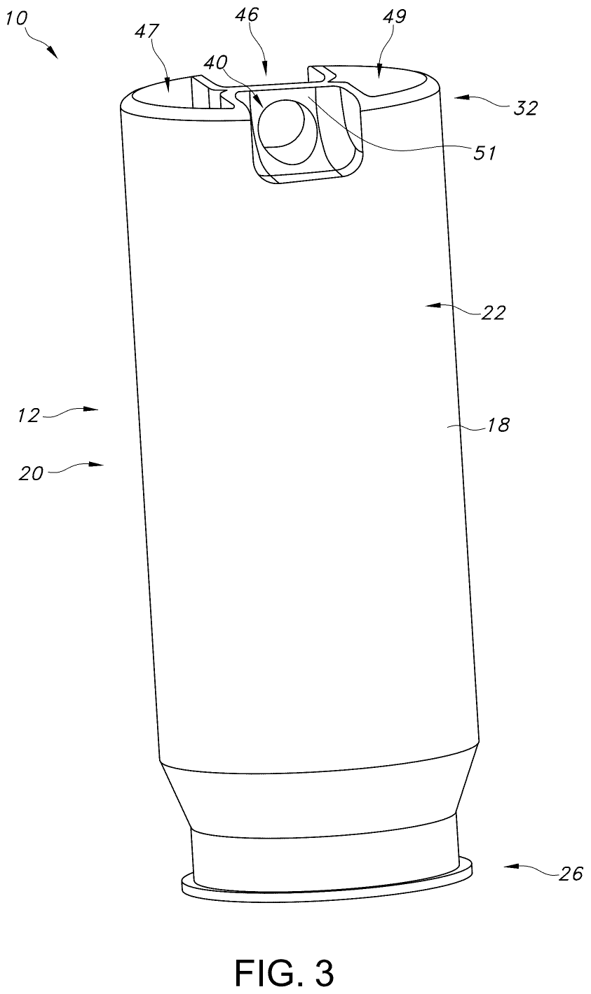

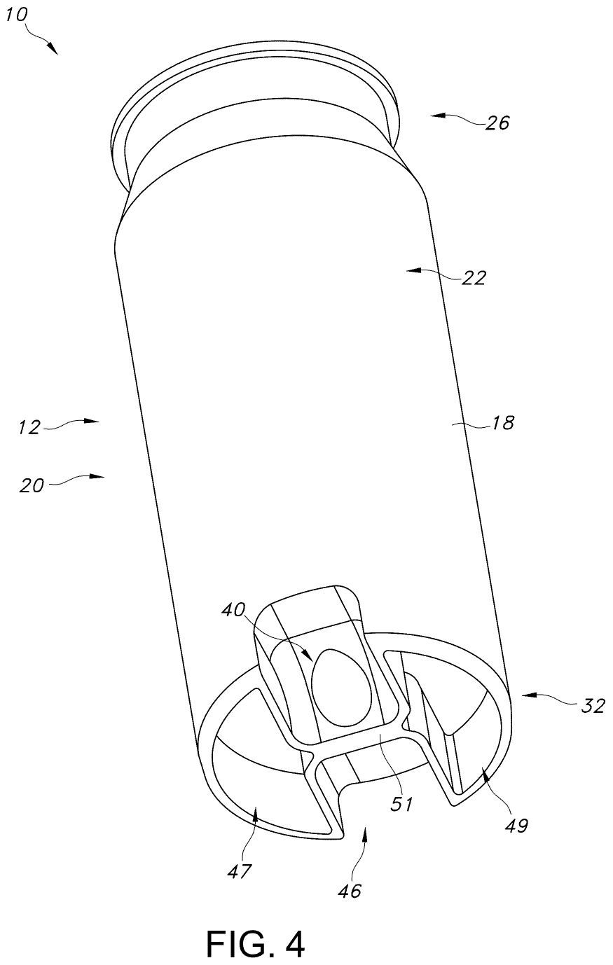

The base 32 of the body 12 may also include a lipped bottom 46 that defines recesses 47, 49 (See FIGS. 3-4). The lipped bottom 46 may be shaped such that the base 32 of the body 12 is configured to provide a vacuum lock when placed on a surface. Thus, the base 32 of the body 12 may be capable of providing a suction fit with a surface on which the enteral feeding bottle 10 is placed. Such a fit may prevent the contents of the enteral feeding bottle 10 from inadvertently spilling. In addition, such a fit may also assist with stabilizing the enteral feeding bottle 10 if the enteral feeding bottle 10 is used for enteral feeding with an enteral feeding device such as the enteral feeding device which will be discussed in greater detail hereinbelow. The stability of the body 12 may also be further enhanced by providing a bridge 51 between the recesses 47, 49 (See FIGS. 3-4). In addition, the body 12 may be supported from the bridge 51 when the enteral feeding bottle 10 is hung from the hole 40. Each of the portions of the body 12 described herein, such as the base 32 and the flanged rim 26, may be one integrated piece. By providing a body 12 as one integrated piece further stability for the body 12 may be provided.

The recessed features integrated into the base of the bottle may also serve as storage pockets for further on-the-go convenience. These pockets can be configured with a removable cover that can store small items such as medications and keys. These pockets further enhance the stability of the bottle on a flat surface while providing additional functionality to the user.

Referring now to FIGS. 2a-2b, the connecting ring 14 is configured to interlock with the flanged rim 26 of the body 12. For example, the connecting ring 14 may have a maximum circumference 31 and a minimum circumference 33. The minimum circumference 33 of the connecting ring 14 may be smaller than the maximum circumference 28 of the flanged rim 26 when the flanged rim 26 is in the expanded state. As a consequence of the minimum circumference 33 of the connecting ring 14 being smaller than the maximum circumference 28 of the flanged rim 26 in the expanded state, the connecting ring 14 may be capable of fitting within the flanged rim 26 when the flanged rim 26 is in an expanded state. In addition, the maximum circumference 28 of the flanged rim 26 in the constricted state may be equal to or smaller than the maximum circumference 31 of the connecting ring 14. As a consequence of the maximum circumference 28 of the flanged rim 26 in the constricted state being equal to or smaller than the maximum circumference 31 of the connecting ring 14, the flanged rim 26 may grip and form an interference fit with the connecting ring 14 when the connecting ring 14 is fitted within the flanged rim 26. Further, the maximum circumference 31 of the connecting ring 14 may be about equal to a maximum circumference 41 of the body 12. As a consequence of providing a connecting ring 14 with an approximately equal maximum circumference as the maximum circumference 41 of the body 12, an enteral feeding bottle 10 may be provided that defines a continuous or approximately continuous profile, especially along the point at which the body 12 and the connecting ring 14 meet. Moreover, the maximum circumference 31 of the connecting ring 14 may also be approximately equal to a maximum circumference 43 of the enteral feeding device adaptor 16 (See FIG. 1). By requiring that the maximum circumference 31 of the connecting ring 14 be approximately equal to a maximum circumference of the enteral feeding device adaptor 16, greater support for the connecting ring 14 may be provided, and the continuous or approximately continuous profile of the enteral feeding bottle 10 may be continued from the connecting ring 14 to the enteral feeding device adaptor 16. In addition, because the maximum circumference 31 of the connecting ring 14 is about equal to a maximum circumference 41 of the body 12, the connecting ring 14 may be configured to surround the angled portion 34 of the body 12 when the connecting ring 14 is interlocked with the flanged rim 26.

In addition, because of the different circumferences 28, 30, 31, 33 of the flanged rim 26 of the body 12 and the connecting ring 14, the flanged rim 26 may also be configured to form a channel 35 between the upper section 36 of the body 12 of the enteral feeding bottle 10 and the flanged rim 26. To achieve this, the connecting ring 14 may include a protrusion 37 extending about a circumference, such as the minimum circumference 33 of the connecting ring 14. In addition, to achieve this, the connecting ring 14 may extend in the axial direction a and be configured to be inserted within the channel 35. Thus, when the connecting ring 14 and the flanged rim 26 are formed as described, the flanged rim 26 may be configured to be compressed by the protrusion 37 of the connecting ring 14 to form the seal. Such a seal may be further enhanced when the enteral feeding device adaptor 16 is provided with the enteral feeding bottle 10 such that the flanged rim 26 is compressed between the protrusion 37 of the connecting ring 14 and an inner surface 39 of the enteral feeding device adaptor 16 to form the seal. Such features may also be enhanced due to the body 12 being formed from a flexible material and the connecting ring 14 and enteral feeding adaptor 16 being formed from rigid materials. Specifically, by having the body 12 be formed from flexible materials, the body 12 may be easily compressed between the connecting ring 14 and the enteral feeding device adaptor 16 when the enteral feeding bottle 10 is fully assembled. In addition, the flexible nature of the body 12 may also aid in nutrition delivery through an enteral feeding system, such as the enteral feeding system which will be described in greater detail hereinbelow, by automatically collapsing as fluid passes through the bottle 10 to an enteral feeding device.

Still referring to FIGS. 2a-2b, the connecting ring 14 may also include external threads 48. The external threads 48 of the connecting ring 14 may assist the connecting ring 14 with connecting with the enteral feeding device adaptor 16 such that the enteral feeding device adaptor 16 is configured to be removably connected with the connecting ring 14. Specifically, the enteral feeding device adaptor 16 may include internal threads 50 which are shaped to form an interlocking fit with the external threads 48 of the connecting ring 14. Because of this, the enteral feeding device adaptor 16 may be screwed onto the connecting ring 14, or vice versa, via the external threads 48 of the connecting ring 14 and the internal threads 50 of the enteral feeding device adaptor 16. Such features may also be achieved or enhanced because the connecting ring 14 and the external feeding device adaptor 16 are formed from rigid materials as described above.

Referring back to FIG. 1, in an embodiment, one or more vents 61 may be present when the connecting ring 14 is attached to the enteral feeding device adaptor 16 (See FIG. 1). These vent(s) 61 could also be provided as a result of a tunnel 63 being defined between the coupling ring 14 and the enteral feeding device adaptor 16 when connected and an opening 65 being provided between the bottom of the enteral feeding device adaptor 16 and the coupling ring 14. Such vent(s) 61 may prevent a vacuum from forming within the enteral feeding bottle 10 when the enteral feeding bottle 10 is used either for direct feeding or used with a bolus delivery system or an enteral feeding system as will be described in greater detail hereinbelow.

The enteral feeding device adaptor 16 includes an opening 58 which is configured to be removably connected with an enteral feeding device or a bolus delivery system device, and thus, provide an enteral feeding system. Examples of enteral feeding devices which may be connected with the enteral feeding bottle 10 at the enteral feeding device adaptor 16 will be discussed in greater detail hereinbelow. The opening 58 of the enteral feeding device adaptor 16 may define a smaller circumference 59 than the opening 24 of the body 12. Specifically, the circumference 59 of the opening 58 may be smaller than the minimum circumference 30 of the body 12 which defines the opening 24. Because the opening 58 has a larger diameter than the opening 24, the enteral feeding bottle 10 may be more easily filled prior to attaching the connecting ring 14 and the enteral feeding device adaptor 16, and more safely retain and dispense fluid nutrition when using the opening 58 of the enteral feeding device adaptor 16.

In addition, the enteral feeding device adaptor 16 may also include a cap 52 to seal the enteral feeding bottle 10. The cap 52 may be a tether cap with a tether 54 formed with the enteral feeding device adaptor 16 such that the cap 52 is not misplaced or otherwise lost. The enteral feeding device adaptor 16 may also include external threads 56 placed along the opening 58 of the enteral feeding device adaptor. The external threads 56 of the enteral feeding device adaptor 16 may better facilitate connection between the enteral feeding bottle 10 and an enteral feeding device or bolus delivery system device as will be discussed in greater detail hereinbelow. In addition, the cap 52 may also include internal threads 53 which are complementary with external threads 56 of the external feeding device adaptor 16 so that the enteral feeding bottle 10 may be easily sealed by the cap 52 if the enteral feeding bottle 10 is, for example, used for storage.

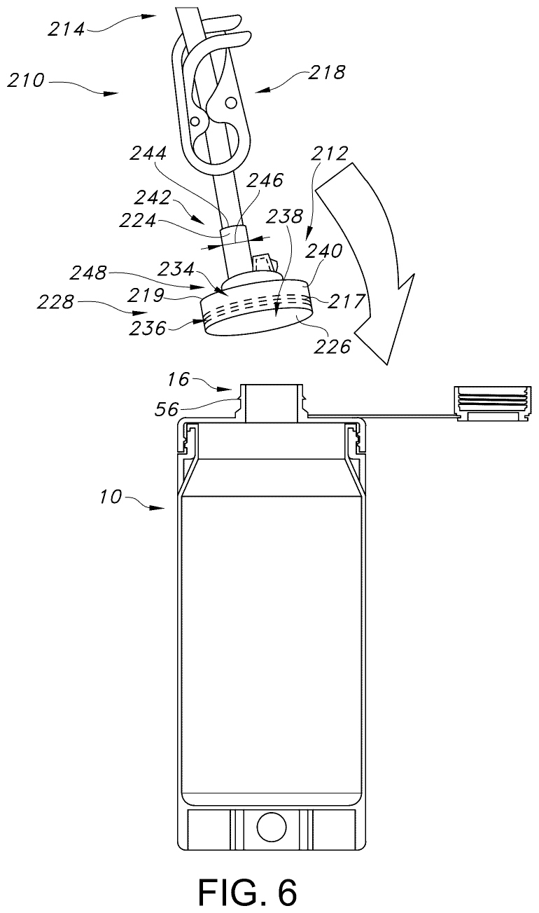

Referring now to FIGS. 5-6, illustrate various views of a bolus delivery system which may be used with the enteral feeding bottle 10. Referring now to the bolus delivery system 210, Referring now to FIG. 5, one embodiment of a bolus feed delivery system 210 is shown. The bolus feed delivery system 210 includes a nutrition adapter 212 configured to be coupled to a nutrition source (see FIG. 6), such as the enteral feeding bottle 10, a tube 214, and a feeding tube adapter 216 configured to be coupled directly with an indwelling feeding tube (not shown). The delivery system 210 may additionally include a flow restriction mechanism 218 configured to enable or occlude flow of nutrition through the tube 214. For instance, the flow restriction mechanism 218 may be formed as a clamp.

As shown in FIG. 5, the nutrition adapter 212 has a body 222 extending from a distal end 224 to a proximal end 226. The proximal end 226 includes a nutrition connector 228 configured and designed to complementarily attach directly to the enteral feeding device adaptor 16. To this end, the proximal end 226 may include a collar 234 having threads 236 formed on an inner surface 238 or outer surface 240 of the collar 234 that are complementary with the external threads 56 of the enteral feeding device adaptor 16. Thus, the external threads 56 of the enteral feeding device adaptor 16 are configured to be interlocked with internal threads 236 of the bolus delivery feed system 210 such that the enteral feeding device adaptor 16 and the nutrition adapter 212 are fluidly coupled with each other.

Referring now to FIG. 6, the body 222 includes a tube coupling 242 at the distal end 224 of the nutrition adapter 212. The tube coupling 242 includes a cylindrical outer surface 244 having a diameter 246 configured to correspond to an inner diameter or outer diameter of the tube 214. Thus, the tube coupling 242 may be inserted into the tube 214 or the tube coupling 242 may surround an outer diameter of the tube 214. In any instance, the body 222 of the nutrition adapter 212 includes a nutrition lumen 248 extending therethrough from the nutrition connector 228 to the tube coupling 242. In this arrangement, when the nutrition adapter 212 is connected to the enteral feeding bottle 10, the nutrition fluid can flow from the enteral feeding bottle 10 through the length of the body 222 from the nutrition connector 228 through the tube coupling 242 and into the tube 214.

Referring back to FIG. 5, the tube 214 has a body 250 that extends from a distal end 252 to a proximal end 254. A flow rate of nutrition through the tube 214 can be determined at least in part by the inner diameter 264 of the tube 214 and a length 266 extending from the distal end 252 to the proximal end 254 of the tube. In general, the larger the inner diameter 264, the higher the flow rate of nutrition through the tube 214. However, the flow rate of nutrition through the tube 214 may be influenced by additional factors, including but not limited to the length and diameter of the nutrition lumen 248 through the body 222 of the nutrition adapter 212, the presence of a flow restriction mechanism 218, the viscosity and/or composition of the nutrition delivered through the tube 214, and other factors.

Still referring to FIG. 5, a feeding tube adapter 216 is coupled to the distal end 252 of the tube 214. The feeding tube adapter 216 has a body 270 that extends from a proximal end 272 to a distal end 274. The body 270 is coupled to the distal end 252 of the tube 214 at the proximal end 272 of the feeding tube adapter 216. At the distal end 274 of the body 270, the feeding tube adapter 216 includes a feeding tube coupling 278. The feeding tube coupling 278 is configured to be inserted directly into a receiving port of an indwelling feeding tube having a lumen (not shown). A feeding tube adapter lumen 280 extends through the body 270 from the proximal end 272 to the distal end 274 to fluidly couple the feeding tube adapter 216 with the tube 214 such that nutrition may be delivered from the tube 214 to the feeding tube when the coupling 278 is inserted within the receiving port of the feeding tube.

The feeding tube coupling 278 may comprise a stem 282 configured to be inserted into the receiving port of the indwelling feeding tube. The stem 282 may form a male connector or coupling configured to be inserted into a female receiving coupling or port of the indwelling feeding tube. The stem 282 may have a cylindrical cross-sectional shape or any other rounded cross-sectional shape. The stem 282 may have a tapered proximal end 284 having a diameter that tapers toward the terminal distal end 281 of the stem 282.

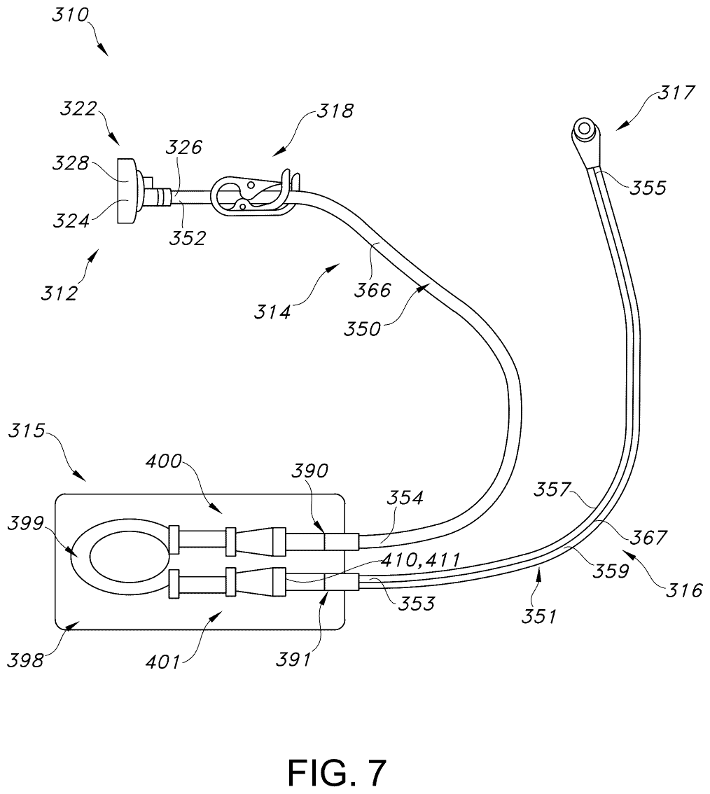

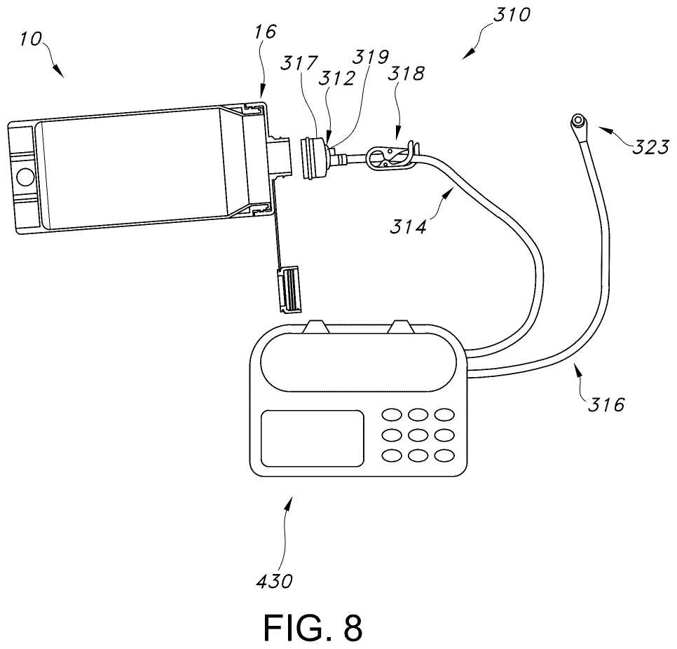

Referring now to FIGS. 7-8, illustrate various views of an enteral feeding system which may be used with the enteral feeding bottle 10. Referring now to FIG. 7, one embodiment of an enteral feeding system 310 is shown. The enteral feeding system 310 includes a nutrition adapter 312 configured to be coupled to a nutrition source, such as the enteral feeding bottle 10. The enteral feeding system also includes a first tube 314, a cartridge 315 configured to be inserted into a peristaltic pump (see FIG. 8), a second tube 316, and a feeding tube adapter 317 configured to be coupled directly with an indwelling feeding tube (not shown). The enteral feeding system 310 may additionally include a flow restriction mechanism 318 configured to enable or occlude flow of nutrition through the first and second tubes 314, 316. For instance, the flow restriction mechanism 318 may be formed as a clamp.

The nutrition adapter 312 has a body 322 extending from a proximal end 324 to a distal end 326. The proximal end 324 includes a nutrition connector 328 configured and designed to complementarily attach directly to a connector 332 of source of nutrition, such as the enteral feeding bottle 10. For instance, the nutrition adaptor 312 may be formed similarly to the nutrition source adaptor 212 with internal threads for fluidly coupling with the enteral feeding bottle 10. Specifically, the nutrition adapter 312 may have a similar coupling as the bolus delivery system 210 and the enteral feeding device adaptor 16 as described with reference to FIGS. 5-6. Thus, like the bolus delivery system 210, the enteral feeding system 10 may have complementary internal threads at its nutrition connector 328 and be capable of forming a fluid coupling with the enteral feeding device adaptor 16. In any instance, the body 322 of the nutrition adapter 312 includes a nutrition lumen 348 extending therethrough from the nutrition connector 328 to the tube coupling 342. In this arrangement, when the nutrition adapter 312 is connected to a source of nutrition 330, the nutrition fluid can flow from the source of nutrition 330 through the length of the body 322 from the nutrition connector 328 through the tube coupling 342 and into the first tube 314.

The first and second tubes 314, 316 each have a body 350, 351 that extends from a proximal end 352, 353 to a distal end 354, 355. A flow rate of nutrition through the first and second tubes 314, 316 can be determined at least in part by the inner diameters 364, 365 of the first and second tubes 314, 316 and a length 366, 367 extending from the proximal ends 352, 353 to the distal ends 354, 355 of the tubes 314, 316. In general, the larger the inner diameters 364, 365, the higher the flow rate of nutrition through the first and second tubes 314, 316. However, the flow rate of nutrition through the first and second tubes 314, 316 may be influenced by additional factors, including but not limited to the length and diameter of the nutrition lumen 348 through the body 322 of the nutrition adapter 312, the presence of a flow restriction mechanism 318, the viscosity and/or composition of the nutrition delivered through the first and second tubes 314, 316, and other factors. Still referring to FIG. 7, a cartridge 315 is attached between the first and second tubes 314, 316. Specifically, the cartridge 315 is located between the proximal end 352 of the first tube 314 and the distal end 355 of the second tube 316. The cartridge 315 includes tube couplings 390, 391.

Referring now to FIG. 8, the cartridge 315 is configured to be inserted into a peristaltic pump 430. For example, the shape of the frame 398 of the cartridge 315 may be customized to fit within any known peristaltic pump used for enteral feeding. The cartridge 315 may include a cartridge tube 399 which can extend in a U-shape from a cartridge inlet 400 to a cartridge outlet 401. The cartridge inlet 400 and the cartridge outlet 401 are configured for coupling to the first and second tubes 314, 316 at the tube couplings 390, 391.

In an embodiment, if the enteral feeding bottle 10 is attached to the bolus delivery system 210 or the enteral feeding system 310, venting between the enteral feeding bottle 10 and the bolus delivery system 210 or the enteral feeding system 310 may be achieved through surface texturing of a sealing surface 217, 317 and/or the roof surface 219, 319 of the nutrition adapter 212, 312 respectively (See FIGS. 6 and 8). Furthermore, both the sealing surface 217, 317 and the roof surface 219, 319 of the nutrition adapter 212, 312 may be textured to allow for the passage of air while maintaining a leak-free system. For example, may be observable using the VDI (“Verein Deutscher Ingenieure”) scale. However, it should be understood that other equivalent texturing scales that provide similar textures may be utilized.

In particular, the surface texturing of both the sealing surface 217, 317 and the roof surface 219, 319 may range from about VDI 24 to about VDI 45, such as about VDI 28 to about 42, such as about VDI 32 to about VDI 38. Further, texturing the sealing surface 217, 317 with a different texture than the roof surface 219, 319 may also provide improved venting. For example, the sealing surface 217, 317 surface texture may range from VDI 24 to about VDI 34, such as VDI 27 to about VDI 34, such as VDI 30 to about VDI 33, while the roof surface 219, 319 surface texture may range from about VDI 35 to about VDI 45, such as about VDI 35 to about VDI 42, such as about VDI 36 to about VDI 39. In an exemplary embodiment, this surface texturing may be a VDI 33 surface finish on the sealing surface 217, 317 and a VDI 36 surface finish on the roof surface 219, 319.

As presently described, the enteral feeding bottle 10 may be used for both feeding and/or storage. For example, the enteral feeding bottle 10 may directly dispense nutritional fluid from the enteral feeding device adaptor 16 to a consumer. This dispensing may be achieved when the enteral feeding bottle 10 is squeezed or constricted by a consumer. In addition, the enteral feeding bottle 10 may also be used with either the bolus delivery system 210 or the enteral feeding system 310 to dispense nutritional fluid enterally to a consumer as described with reference to FIGS. 5-8. In addition, the enteral feeding bottle 10 may be used as a storage container when feeding is not presently desired. Specifically, the enteral feeding bottle 10 may be filled with nutritional fluid and placed within storage, such as refrigerated storage, for use later. The enteral feeding bottle 10 may also be stacked with other enteral feeding bottles 10. In particular, the enteral feeding device adaptor 16 may be removed from the enteral feeding bottle 10 and a flat lid (not shown) with threads complementary to the external threads 48 may be coupled to the connecting ring 14. In this configuration, the enteral feeding bottle 10 may be stacked on top of other enteral feeding bottles 10 for storage.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. An enteral feeding bottle, the enteral feeding bottle comprising:
a body comprising an exterior and an interior chamber, the body further comprising an opening to the interior chamber of the body and a base, the body further comprising a flanged rim along the opening, wherein the body is formed from a flexible material, wherein the flexible material comprises silicone or a thermoplastic elastomer;
a connecting ring configured to interlock with the flanged rim of the body;
an enteral feeding device adaptor configured to removably connect with the connecting ring, the enteral feeding device adaptor comprising an opening configured to be removably connected with an enteral feeding device,
wherein a seal is formed between the flanged rim, the connecting ring, and the enteral feeding device adaptor.

2. The enteral feeding bottle of claim 1, wherein the flanged rim defines an expanded state and a constricted state, wherein a minimum circumference of the connecting ring is smaller than a maximum circumference of the flanged rim in the expanded state.

3. The enteral feeding bottle of claim 2, wherein the maximum circumference of the flanged rim in the constricted state is equal to or smaller than the maximum circumference of the connecting ring.

4. The enteral feeding bottle of claim 1, wherein a maximum circumference of the connecting ring is about equal to a maximum circumference of the body.

5. The enteral feeding bottle of claim 1, wherein the body defines an angled portion, wherein the connecting ring is configured to surround the angled portion when the connecting ring is interlocked with the flanged rim.

6. The enteral feeding bottle of claim 1, wherein the connecting ring comprises external threads and the enteral feeding device adaptor comprises internal threads, wherein the external threads of the connecting ring are configured to interlock with the internal threads of the enteral feeding device adaptor.

7. The enteral feeding bottle of claim 1, wherein the enteral feeding device adaptor comprises a tethered cap.

8. The enteral feeding bottle of claim 1, wherein the base of the body comprises a hole arranged about an axis, wherein the axis of the hole is approximately perpendicular to an axis about which the opening of the body is arranged.

9. The enteral feeding bottle of claim 1, wherein the base of the body comprises a lipped bottom configured to provide a vacuum lock when placed on a surface.

10. The enteral feeding bottle of claim 1, wherein the body, the connecting ring, and the enteral feeding device adaptor each comprise a cylinder.

11. The enteral feeding bottle of claim 1, wherein the opening of the enteral feeding device adaptor comprises external threads, wherein the external threads of the enteral feeding device adaptor are configured to be interlocked with internal threads of the enteral feeding device.

12. The enteral feeding bottle of claim 1, wherein the connecting ring and the enteral feeding device adaptor comprise a rigid material.

13. The enteral feeding bottle of claim 1, wherein the body of the enteral feeding bottle is compressible in a radial direction and not compressible in an axial direction.

14. The enteral feeding bottle of claim 1, wherein the flanged rim forms a channel between an upper section of the body of the enteral feeding bottle and the flanged rim, and the connecting ring comprises a protrusion extending in an axial direction and configured to be inserted within the channel.

15. The enteral feeding bottle of claim 14, wherein the flanged rim is configured to be compressed between the protrusion of the connecting ring and an inner surface of the enteral feeding device adaptor to form the seal.

16. The enteral feeding bottle of claim 14, wherein the protrusion extends about a circumference of the connecting ring.

17. An enteral feeding system comprising:
an enteral feeding bottle comprising:
a body comprising an exterior and an interior chamber, the body further comprising an opening to the interior chamber of the body and a base, the body further comprising a flanged rim along the opening, wherein the body is formed from a flexible material, wherein the flexible material comprises silicone or a thermoplastic elastomer,
a connecting ring configured to interlock with the flanged rim of the body, and
an enteral feeding device adaptor configured to removably connect with the connecting ring, the enteral feeding device adaptor comprising an opening configured to be removably connected with an enteral feeding device, wherein a seal is formed between the flanged rim, the connecting ring, and the enteral feeding device adaptor; and
an enteral feeding device comprising:
a nutrition adapter comprising a coupling configured to fluidly couple with the enteral feeding device adaptor,
a tube fluidly coupled to the nutrition adapter, and
a feeding tube adapter fluidly coupled to the tube,
wherein the nutrition adapter, the tube, and the feeding tube adapter are formed as one piece.

18. The enteral feeding system of claim 17, wherein a minimum circumference of the connecting ring is smaller than a maximum circumference of the flanged rim.

19. The enteral feeding system of claim 18, wherein the flanged rim defines an expanded state and a constricted state, wherein the maximum circumference of the flanged rim in the constricted state is equal to or smaller than the maximum circumference of the flanged rim.

20. The enteral feeding system of claim 17, wherein the body defines an angled portion, wherein the connecting ring is configured to surround the angled portion when the connecting ring is interlocked with the flanged rim.
